(19) United States
(12) Patent Application Publication
(10) Pub. No.: US 2024/0166360 A1
(43) Pub. Date: May 23, 2024

(54) AIRCRAFT TAIL MOUNTED FUEL CELL POWER TRAIN AND THERMAL MANAGEMENT SYSTEMS

(71) Applicant: EMBRAER S.A., São José dos Campos – SP (BR)

(72) Inventors: Rodolfo da Silva COLLARES, São José dos Campos – SP (BR); Rui Mitio KATSUTANI, São José dos Campos – SP (BR); Luiz Fernando Tedeschi OLIVEIRA, São José dos Campos – SP (BR); Carlos Henrique Belloni MOURÃO, São José dos Campos – SP (BR)

(21) Appl. No.: 18/505,642

(22) Filed: Nov. 9, 2023

Related U.S. Application Data
(60) Provisional application No. 63/427,232, filed on Nov. 22, 2022.

(51) Int. Cl. B64D 27/24; B64D 37/30; H01M 8/2465

(52) U.S. Cl. CPC B64D 27/24; B64D 37/30; H01M 8/2465; H01M 2250/20

(57) ABSTRACT

Fuel cell and power train (FCPT) systems are provided and adapted to being operatively mounted at a tail section of an aircraft fuselage. The FCPT systems will include port and starboard subsystems each being comprised of a nacelle adapted to being laterally attached to a respective side of the tail section of the fuselage, an electric motor contained in the nacelle, a propeller assembly mounted to the nacelle and operatively connected to and adapted to be driven by the electric motor contained therein, and at least one fuel cell positioned in the tail section of the fuselage to supply electrical power to the electric motor contained in the nacelle. One or more hydrogen fuel tanks may be mounted within the tail section of the fuselage to provide a source of hydrogen gas (H₂) as fuel to the fuel cells.

### CROSS-REFERENCE TO RELATED APPLICATION

This application is based on and claims domestic priority benefits from U.S. Provisional Application Ser. No. 63/427,232 filed on Nov. 22, 2022, the entire content of which is expressly incorporated hereinto by reference.

### FIELD

The embodiments disclosed herein relate generally to fuel cell systems. In especially preferred forms, the embodiments disclosed herein relate to fuel cell powered electrical power train systems especially useful for the aeronautics and aerospace industries.

### BACKGROUND

With the exception of relatively small aircraft, the vast majority of airplanes in service today operate with thermal engines which combust fossil fuels. However, electric solutions to power aircraft combining an electrical motor to either battery energy or fuel cells are extensively being studied generating a number of scientific publications and the creation of demonstrator aircraft.

To date, however, it is believed that no consecrated installation and layout solutions for aircraft fuel cells in aircraft power train systems has been proposed. It is therefore providing such solutions that the embodiments disclosed herein are directed.

### SUMMARY

Broadly, the embodiments disclosed herein are directed toward compact and space optimized layouts to accommodate fuel cells in a tail region of a multi-engine electric motor-driven propeller aircraft. The propellers may be in either a pusher configuration or a tractor configuration. In preferred embodiments, the fuel cell systems and remaining power train (e.g., electric motor and associated propellers) are employed to power a dual propeller aircraft.

According to preferred embodiments, a fuel cell and power train (FCPT) system is provided which is adapted to being operatively mounted at a tail section of an aircraft fuselage. The FCPT system will include port and starboard subsystems each being comprised of a nacelle adapted to being laterally attached to a respective side of the tail section of the fuselage, an electric motor contained in the nacelle, a propeller assembly mounted to the nacelle and operatively connected to and adapted to be driven by the electric motor contained therein, and at least one fuel cell positioned in the tail section of the fuselage to supply electrical power to the electric motor contained in the nacelle. One or more hydrogen fuel tanks may be mounted within the tail section of the fuselage to provide a source of hydrogen gas (H₂) as fuel to the fuel cells.

The port and starboard subsystems of the FCPT system according to some embodiments may further include first and second fuel cells positioned in the tail section of the aircraft. The first fuel cell may thus be operatively connected to a fuselage radiator heat exchanger positioned in the tail section of the aircraft, while the second fuel cell may be operatively connected to a nacelle radiator heat exchanger positioned in the nacelle.

The FCPT system may further comprise an empennage root-mounted air inlet duct to direct ram air to the fuselage radiator heat exchanger. The fuselage may have a tail section which includes a tail cone having a variable area nozzle assembly to allow air exiting the fuselage radiator heat exchanger to be discharge to an external aircraft environment. The nacelle may also comprise an air inlet to direct ram air to the nacelle radiator fuel heat exchanger and a variable area nozzle outlet to allow air discharged from the nacelle radiator heat exchanger to be discharged to an external aircraft environment. The variable area nozzle outlet of the nacelle may be annular.

According to some embodiments, each of the fuselage radiator heat exchanger and the nacelle radiator heat exchanger may include a respective fan operatively mounted in the tail section of the fuselage and the nacelle.

These and other aspects and advantages of the present invention will become clearer after careful consideration is given to the following detailed description of the preferred exemplary embodiments thereof.

### BRIEF DESCRIPTION OF ACCOMPANYING DRAWINGS

The disclosed embodiments of the present invention will be better and more completely understood by referring to the following detailed description of exemplary non-limiting illustrative embodiments in conjunction with the drawings of which:

FIGS. 1 and 2 are respectively aft-looking and forward looking perspective views of an exemplary aircraft tail region that is partially sectioned to reveal an exemplary layout of a fuel cell power train and thermal management system in accordance with an embodiment of the present invention;

FIG. 3 is a schematic diagram showing the fuel cell power train and thermal management system of the embodiment depicted in FIGS. 1 and 2; and

FIG. 4 is a schematic diagram showing the fuel cell power train and thermal management system according to another embodiment of the invention.

### DETAILED DESCRIPTION OF EMBODIMENTS

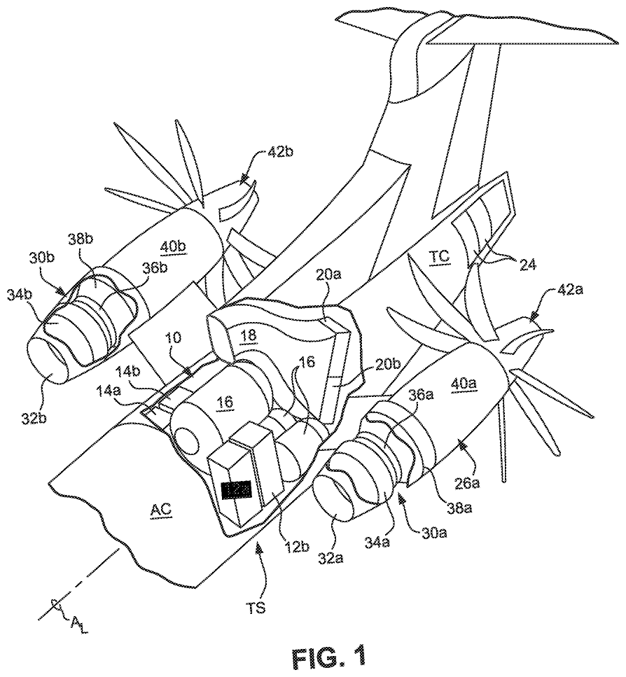

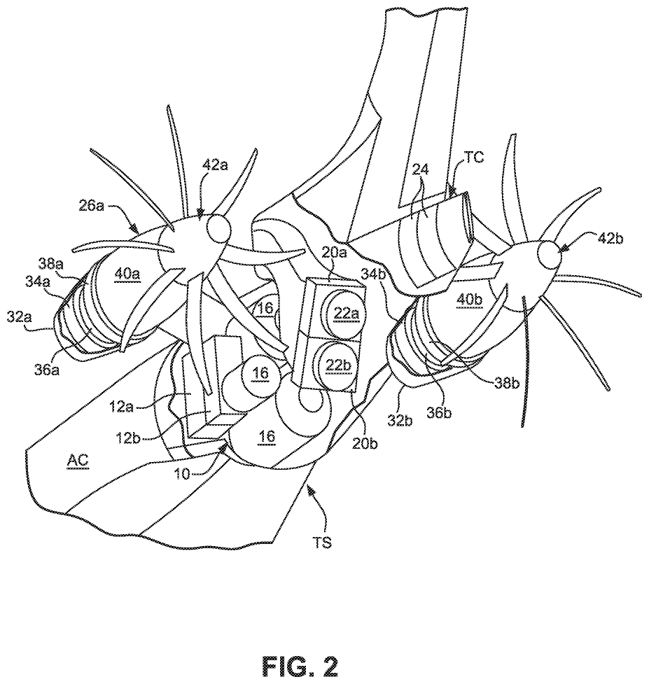

As is shown in FIGS. 1 and 2, a fuel cell and power train (FCPT) system 10 in accordance with an embodiment of the present invention is shown as being installed in the tail section TS of the aircraft AC. As shown, the FCPT system 10 includes respective port and starboard subsystems respectively including port and starboard pairs of fuel cells (FCs) 12a, 12b and 14a, 14b. A plurality of hydrogen (H₂) tanks 16 are positioned in the tail section TS of the fuselage and serve to store the hydrogen gas used as fuel for the fuel cells 12a, 12b, 14a, 14b. The fuel cells 12a, 12b, 14a, 14b are in and of themselves conventional fuel cells which generate electrical power by an electrochemical reaction from supplied hydrogen (H₂) fuel gas. See for example U.S. Pat. Nos. 7,559,389 and 8,607,909, the entire contents of which are expressly incorporated hereinto by reference. An empennage root-mounted air inlet duct 18 directs ambient inlet air to downstream radiator heat exchangers 20a, 20b equipped with fans 22a, 22b (see FIG. 2). The tail cone TC of the aircraft AC is provided with a variable area nozzle assembly 24 to allow air exiting the radiator heat exchangers 20a, 20b to be discharged to the external aircraft environment.

Port and starboard nacelles 26a, 26b are laterally mounted to the tail section TS in parallel alignment with the longitudinal axis A_{L} of the aircraft AC and enclose a respective thermal management system 30a, 30b. Each of the thermal management systems 30a, 30b is respectively comprised of a frontal air inlet 32a, 32b, an interior nacelle radiator heat exchanger 34a, 34b, a fan 36a, 36b and a variable annular nozzle outlet 38a, 38b. The aft portion of the nacelles 26a, 26b also enclose a respective electric motor 40a, 40b and a pusher propeller assembly 42a, 42b operatively associated with the motor 40a, 40b, respectively.

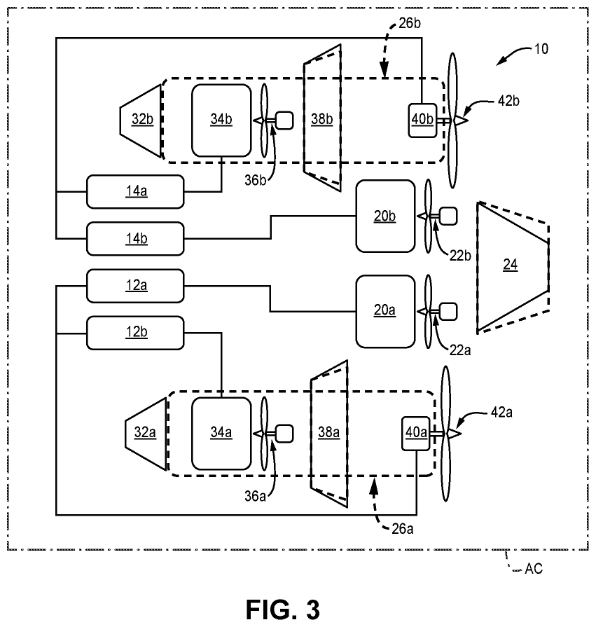

The operative interconnections for the FCPT system 10 are shown schematically in FIG. 3. As depicted therein, the aircraft AC is powered by the independent port and starboard pairs of fuel cells 12a, 12b and 14a, 14b, respectively, installed in the unpressurized tail section TS of the aircraft AC. Each of the port and starboard pairs of fuel cells 12a, 12b and 14a, 14b serve to provide electrical power the port and starboard electric engines 40a, 40b, respectively.

Each of port and starboard fuel cells 12a, 14a is independently provided with an operatively associated radiator heat exchanger 34a, 34b mounted in the nacelles 26a, 26b, respectively, while each of the port and starboard fuel cells 12b, 14b is independently provided with an operatively associated radiator heat exchanger 20a, 20b mounted in the tail section TS of the aircraft AC as shown in FIGS. 1A and 1B.

The radiator heat exchangers, 20a, 20b mounted in the tail section TS of the aircraft AC perform air/liquid heat exchange with ram air provided by the empennage root-mounted air inlet duct 18 while the radiator heat exchangers 34a, 34b mounted in the nacelles 26a, 26b perform air/liquid heat exchange with ram air introduced through the frontal air inlets 32a, 32b, respectively. The variable area nozzles 24 provided in the tail cone TC of the aircraft AC and the variable area nozzles 38a, 38b modulate the ram air flow to the minimum required to achieve the designed heat exchange so as to minimize pressure losses.

The layout and arrangement of the FCPT system 10 as described above allows for the installation of a fuel cell based power train with great integration between heat management systems and power train components. The multiple fuel cells individual operatively associated radiator heat exchangers configuration (i.e., a pair of radiator heat exchangers on the nacelles and a pair of radiator heat exchangers inside tail section of the aircraft fuselage) allows installation of radiators with a relatively large frontal area with minimal impact on the slender profile of the aircraft. Further, pusher propellers create greater room for propeller installation since the propellers are installed in a relatively thinner portion of the tail section. The pusher propellers also generate less cabin noise as well due to their being further displaced in an aftwise direction relative to the pressurized cabin portion of the aircraft fuselage.

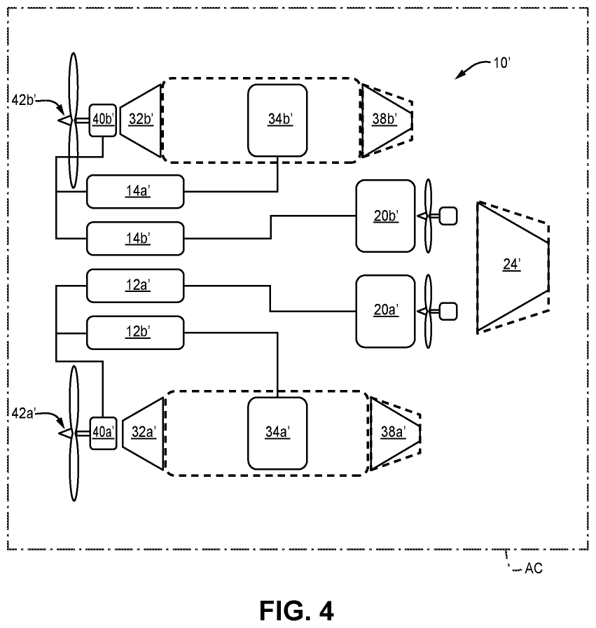

An alternative configuration for a FCPT system 10′ having tractor propeller assemblies 42a′, 42b′ rather than the pusher propeller assemblies 42a, 42b as described previously is shown in FIG. 4. In this regard, common elements between the FCPT system 10′ shown in FIG. 4 to those in the FCPT system 10 shown in FIG. 3 discussed above will be designated with the same reference numeral having a prime (′) mark. It will be understood therefore that such components will have the same function in the FCPT system 10′ as the function described in relation to the FCPT 10 and will therefore not be discussed in further detail.

The FCPT system 10′ shown in FIG. 4 has the advantage to dispense the radiator fans 36a, 36b mounted in the nacelles 26am 26b associated with the FCPT system 10 thereby taking advantage of the propeller stream dynamic pressure. However, having the propeller assemblies 42a′, 42b′ in forward-facing nacelle position can present more cabin noise and may present further installation restrictions due proximity to the aircraft fuselage.

While reference is made to particular embodiments of the invention, various modifications within the skill of those in the art may be envisioned. Therefore, it is to be understood that the invention is not to be limited to the disclosed embodiment, but on the contrary, is intended to cover various modifications and equivalent arrangements included within the spirit and scope thereof.

What is claimed is:

1. A fuel cell and power train (FCPT) system adapted to being operatively mounted at a tail section of an aircraft fuselage, wherein the FCPT system includes port and starboard subsystems each being comprised of:
(i) a nacelle adapted to being laterally attached to a respective side of the tail section of the fuselage;
(ii) an electric motor contained in the nacelle,
(iii) a propeller assembly mounted to the nacelle and operatively connected to and adapted to be driven by the electric motor contained therein,
(iv) at least one fuel cell positioned in the tail section of the fuselage to supply electrical power to the electric motor contained in the nacelle.

2. The FCPT system according to claim 1, wherein the FCPT system further comprises at least one hydrogen gas fuel tank adapted to being positioned within the tail section of the fuselage and to be operative connected to the at least one fuel cell to provide a source of hydrogen gas for the at least one fuel cell.

3. The FCPT system according to claim 2, wherein FCPT system comprises a plurality of hydrogen gas fuel tanks.

4. The FCPT system according to claim 1, wherein each of the port and starboard subsystems of the FCPT system further includes first and second fuel cells positioned in the tail section of the aircraft.

5. The FCPT system according to claim 4, wherein
the first fuel cell is operatively connected to a fuselage radiator heat exchanger positioned in the tail section of the aircraft, and wherein
the second fuel cell is operatively connected to a nacelle radiator heat exchanger positioned in the nacelle.

6. The FCPT system according to claim 5, wherein the FCPT system further comprises an empennage root-mounted air inlet duct to direct ram air to the fuselage radiator heat exchanger.

7. The FCPT system according to claim 6, wherein the fuselage has a tail section of the fuselage includes a tail cone having a variable area nozzle assembly to allow air exiting the fuselage radiator heat exchanger to be discharge to an external aircraft environment.

8. The FCPT system according to claim 5, wherein the nacelle further comprises an air inlet to direct ram air to the nacelle radiator fuel heat exchanger.

9. The FCPT system according to claim 8, wherein the nacelle includes a variable area nozzle outlet to allow air discharged from the nacelle radiator heat exchanger to be discharged to an external aircraft environment.

10. The FCPT system according to claim 9, wherein the variable area nozzle outlet is annular.

11. The FCPT system according to claim 5, wherein each of the fuselage radiator heat exchanger and the nacelle radiator heat exchanger include a respective fan operatively mounted in the tail section of the fuselage and the nacelle.

12. The FCPT system according to claim 1, wherein the propeller assembly includes a pusher mounted propeller

13. The FCPT system according to claim 1, wherein the propeller assembly includes a tractor mounted propeller.

14. A multi-engine electric motor-driven aircraft which comprises a fuselage and the FCPT system according to claim 1 operatively positioned at the tail section of the fuselage.
